(19) United States
(12) Patent Application Publication
(10) Pub. No.: US 2011/0104322 A1
(43) Pub. Date: May 5, 2011

(54) TEMPLATES USED FOR NANOIMPRINT LITHOGRAPHY AND METHODS FOR FABRICATING THE SAME

(75) Inventors: Kunsik PARK, Daejeon (KR); Dong-Pyo Kim, Gwangmyeong (KR); Ji Man Park, Daejeon (KR); Kyu-Ha Baek, Daejeon (KR); Lee-Mi Do, Daejeon (KR)

(73) Assignee: Electronics and Telecommunications Research Institute, Daejeon (KR)

(21) Appl. No.: 12/763,380

(22) Filed: Apr. 20, 2010

(30) Foreign Application Priority Data
Nov. 3, 2009 (KR) 10-2009-0105358

(51) Int. Cl. B28B 11/08; B05D 3/10

(52) U.S. Cl. 425/385; 427/133; 427/255.7; 216/37; 977/902

(57) ABSTRACT

Provided are a template used for nanoimprint lithography and a method for fabricating the same. A raised first deposition layer pattern including at least one downwardly sloped side surface is formed on a substrate. A second deposition layer pattern covering the side surface of the raised first deposition layer pattern and progressively decreasing in width downward along the side surface of the raised first deposition layer pattern is formed. A third deposition layer is formed on the entire surface of a structure on which the second deposition layer pattern. A second deposition layer nano pattern between the raised first deposition layer pattern and a planarized third deposition layer is formed by planarizing the third deposition layer to expose upper surfaces of the raised first deposition layer pattern and the second deposition layer pattern. An intaglio nano pattern defined by side surfaces sloped downward from upper surfaces of the raised first deposition layer pattern and the planarized third deposition layer to the surface of the substrate is formed by removing the second deposition layer nano pattern.

### CROSS-REFERENCE TO RELATED APPLICATIONS

This U.S. non-provisional patent application claims priority under 35 U.S.C. §119 of Korean Patent Application No. 10-2009-0105358, filed on Nov. 3, 2009, the entire contents of which are hereby incorporated by reference.

### BACKGROUND OF THE INVENTION

The present invention disclosed herein relates to templates used for lithography and methods for fabricating the same, and more particularly, to templates used for nanoimprint lithography and methods for fabricating the same.

Microelectronics is currently in the midst of a miniaturization trend towards very fine scaling. While current products are being fabricated with structure sizes below 1 μm, an underlying need exists to further reduce this dimension to below 100 nm. Research on nano devices calls for fabrication technology that can commercially apply devices under 10 nm in size.

The most important technologies for fabricating micro and nano structures respectively include different forms of lithography.

NanoImprint Lithography (NIL) is the most well-known technology for reproducing nanostructures—i.e., structures that are about 100 nm or less in size.

Nanoimprint lithography technologies to date have been limited to nanoimprinting of devices with small overall areas—preferably areas of about several square centimeters (cm²).

In a nanoimprint lithography process, a substrate to be patterned is covered with a moldable layer. A pattern that is to be transferred to the substrate is preset three-dimensionally in a stamp or a template. The stamp is made to contact the moldable layer, and the moldable layer may preferably be softened with heat. Then the stamp is moved perpendicularly toward the softened moldable layer, and is inserted into the softened moldable layer, so that the pattern of the stamp is imprinted in the moldable layer. The stamp is then removed from the moldable layer, and the moldable layer is cooled. Then, by re-duplicating the pattern of the stamp in the substrate through an etching process, the nanoimprint lithography process is completed.

### SUMMARY OF THE INVENTION

The present invention provides templates used for nanoimprint lithography applied to large areas having both nano and micro patterns.

The present invention also provides methods for fabricating templates on which nano and micro patterns coexist, and for nanoimprint lithography capable of easily adjusting nano pattern sizes.

Embodiments of the present invention provide templates for nanoimprint lithography. A template for nanoimprint lithography may include a substrate, and layer patterns defining an intaglio nano pattern and a micro pattern on a substrate. The layer patterns defining the intaglio nano pattern may include side surfaces with an upward slope from a surface of the substrate.

In some embodiments, the layer patterns defining the intaglio micro pattern may include side surfaces with an upward slope from the surface of the substrate.

In other embodiments, the template may further include an etch barrier layer interposed between the substrate and the layer patterns.

In other embodiments of the present invention, templates for nanoimprint lithography are provided. A template for nanoimprint lithography may include a substrate with an intaglio nano pattern and an intaglio micro pattern formed inward from a surface of the substrate. The substrate defining the intaglio nano pattern may have side surfaces of a downward slope from the surface of the substrate.

In other embodiments, the substrate may define the intaglio micro pattern includes side surfaces with a downward slope from the surface of the substrate.

In still other embodiments of the present invention, methods for fabricating templates for nanoimprint lithography are provided. The methods may include: forming a raised first deposition layer pattern on a substrate, the raised first deposition layer pattern including at least one side surface sloped downward from an upper surface thereof to a surface of the substrate; forming a second deposition layer pattern to cover the at least one downwardly sloped side surface of the raised first deposition layer pattern, the second deposition layer pattern having a progressively decreasing width downward from an upper portion to a lower portion of the side surface of the raised first deposition layer pattern; forming a third deposition layer on an entire surface of a structure on which the second deposition layer pattern is formed; forming a second deposition layer nano pattern by planarizing the third deposition layer to simultaneously expose upper surfaces of the raised first deposition layer pattern and the second deposition layer pattern, the second deposition layer nano pattern between the raised first deposition layer pattern and the planarized third deposition layer; and forming an intaglio nano pattern by removing the second deposition layer nano pattern from between the raised first deposition layer pattern and the planarized third deposition layer, the intaglio nano pattern defined by side surfaces sloped downward from upper surfaces of the raised first deposition layer pattern and the planarized third deposition layer to the surface of the substrate.

In other embodiments, the forming the raised first deposition layer pattern may include depositing a first deposition layer on the substrate, and patterning the first deposition layer to have at least one side surface downwardly sloped from the upper surface of the first deposition layer to the surface of the substrate.

In still other embodiments, the at least one downwardly sloped side surface may form an angle with the surface of the substrate of between about 80° to about 90°.

In even other embodiments, the method may further include, prior to the forming the raised first deposition layer pattern, forming an etch barrier layer on an entire surface of the substrate. The etch barrier layer may be formed of a material with higher etch selectivity than the raised first deposition layer pattern, the second deposition layer pattern, and the third deposition layer.

In yet other embodiments, the method may further include, following the forming the intaglio nano pattern, removing the etch barrier layer exposed by the intaglio nano pattern through an etching process using the raised first deposition layer pattern and the planarized third deposition layer as a mask.

In further embodiments, the forming the second deposition layer pattern may include: depositing a second deposition layer on an entire surface of a structure on which the raised first deposition layer pattern is formed, the second deposition layer being progressively reduced in width from the upper portion to the lower portion of the side surface of the raised first deposition layer pattern; and patterning the second deposition layer to cover the at least one downwardly sloped side surface of the raised first deposition layer pattern.

In still further embodiments, the depositing the second deposition layer may use a Plasma Enhanced Chemical Vapor Deposition (PECVD) method or a low temperature Low Pressure Chemical Vapor Deposition (LPCVD) method.

In even further embodiments, the second deposition layer pattern may be formed as a spacer for covering the side surfaces of the raised first deposition layer pattern.

In yet further embodiments, the planarizing the third deposition layer may use a Chemical Mechanical Polishing (CMP) method.

In much further embodiments, the method may further include, prior to the planarizing the third deposition layer, forming an etch stop layer on the third deposition layer. The etch stop layer may be formed of a material with higher etch selectivity than the third deposition layer.

In still much further embodiments, the method may further include transferring the intaglio nano pattern into the substrate through an etching process using the raised first deposition layer pattern and the planarized third deposition layer as a mask, to provide the substrate with side surfaces sloping downward from the surface thereof.

In even much further embodiments, the method may further include, following the transferring the intaglio nano pattern into the substrate, removing the planarized third deposition layer, the second deposition layer pattern, and the raised first deposition layer pattern.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIGS. 1A and 1B are perspective views illustrating templates for nanoimprint lithography according to embodiments;

FIGS. 2A to 13A are perspective views illustrating methods for fabricating templates for nanoimprint lithography according to embodiments; and

FIGS. 2B to 13B are sectional views of FIGS. 2A to 13A, respectively, taken along lines I-I′.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. In the drawings, like reference numerals refer to like elements throughout.

In the following description, the technical terms are used only for explaining a specific exemplary embodiment while not limiting the present invention. The terms of a singular form may include plural forms unless referred to the contrary.

The meaning of “include,” “comprise,” “including,” or “comprising,” specifies a property, a region, a fixed number, a step, a process, an element and/or a component but does not exclude other properties, regions, fixed numbers, steps, processes, elements and/or components. Since preferred embodiments are provided below, the order of the reference numerals given in the description is not limited thereto. It will also be understood that when a layer is referred to as being “on” another layer or substrate, it can be directly on the other layer or substrate, or intervening layers may also be present.

Additionally, the embodiments in the detailed description will be described with sectional views as ideal exemplary views of the present invention. Also, in the figures, the dimensions of layers and regions are exaggerated for effective technical description. Accordingly, shapes of the exemplary views may be modified according to manufacturing techniques and/or allowable errors. Therefore, the embodiments of the present invention are not limited to the specific shapes illustrated in the exemplary views, and may include other shapes that may be created according to manufacturing processes. For example, an etch region illustrated with right angles may be rounded or be configured with a predetermined curvature. Therefore, areas exemplified in the drawings have general properties, and are used to illustrate specific shapes of certain regions, and should not be construed as limiting the scope of the present invention.

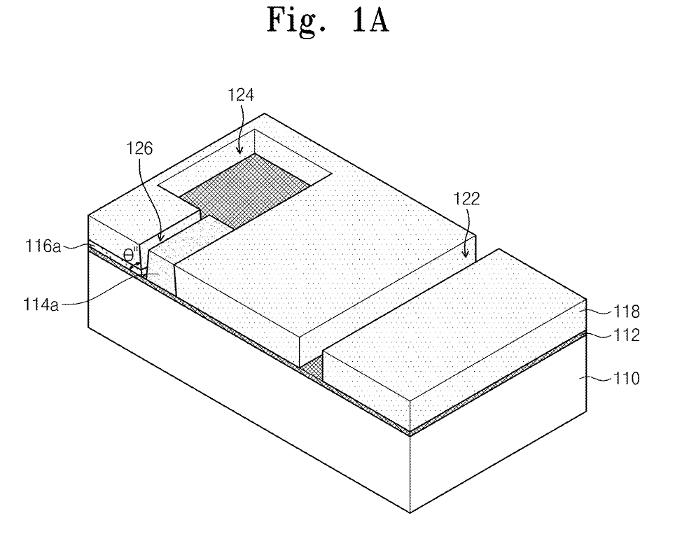

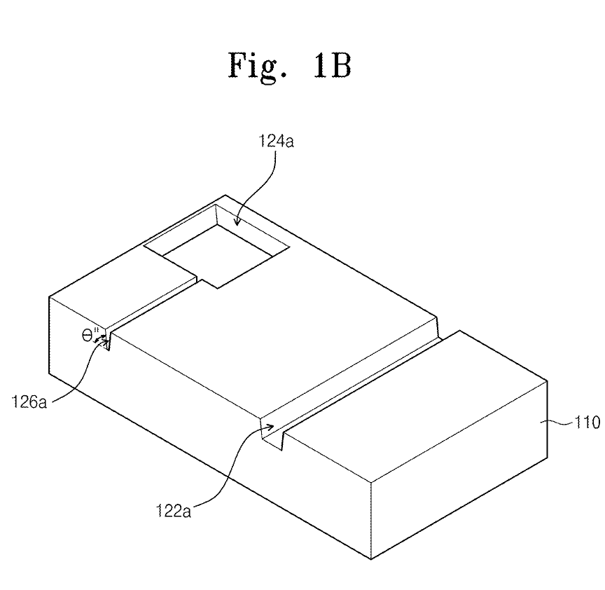

FIGS. 1A and 1B are perspective views illustrating templates for nanoimprint lithography according to embodiments.

Referring to FIG. 1A, a template for nanoimprint lithography includes a substrate 110 and layer patterns 114a and 118 constituting an intaglio nano pattern 126 and intaglio micro patterns 122 and 124.

The substrate 110 may include quartz, polycarbonate, or silicon. Also, the substrate 110 may have ultraviolet ray (UV ray) transmissivity.

The layer patterns 114a and 118 forming the intaglio nano pattern 126 may have side surfaces of an upward slope (θ″) from the surface of the substrate 110. The angle of the upward slope (θ″) of side surfaces of the layer patterns 114a and 118 forming the intaglio nano pattern 126 may be about 80° to about 85°. Further, the layer patterns 114a and 118 forming the intaglio micro patterns 122 and 124 may have upwardly-sloped side surfaces from the surface of the substrate 110. The upward slopes of the side surfaces of the layer patterns 114a and 118 forming the intaglio micro patterns 122 and 124 may be in the same range as the upward slope (θ″) of the side surfaces of the layer patterns 114a and 118 forming the intaglio nano pattern 126, or may be a higher range of about 80° to about 90°.

Here, because there are alternate interior angles between the upward slope (θ″) from the surface of the substrate 110 and downward slope from an upper . surface s of the layer patterns 114a and 118, it should be understood that even when the detailed description should oscillate between the terms “upward” and “downward” according to need, the two terms refer to the same slope.

An etch barrier layer 112 interposed between the substrate 110 and the layer patterns 114a and 118 may be further included. The etch barrier layer 112 may be used to facilitate the forming of the layer patterns 114a and 118 forming the intaglio nano pattern 126 and intaglio micro patterns 122 and 124.

Referring to FIG. 1B, a template for nanoimprint lithography includes a substrate 110 having an intaglio nano pattern 126a and intaglio micro patterns 122a and 124a formed inward from the surface thereof.

The substrate 110 may include glass, quartz, polycarbonate, or silicon. The substrate 110 may also have UV ray transmissivity.

The substrate 110 forming the intaglio nano pattern 126a may have side surfaces with downward slopes from the surface thereof. The angle of the downward slope (θ″) of the side surfaces of the substrate 110 forming the intaglio nano pattern 126a may also be about 80° to about 85°. Further, the substrate 110 forming the intaglio micro patterns 122a and 124a may have side surfaces downwardly sloped from the surface of the substrate 110. The downward slope of the side surfaces of the substrate 110 forming the intaglio micro patterns 122a and 124a may be the same as the downward slope (θ″) of the side surfaces of the substrate 110 in which the intaglio nano pattern 126a is formed, or may be greater in a range of about 80° to about 85°.

A template for nanoimprint lithography according to embodiments has intaglio nano patterns 126 or 126a with a downward slope from a surface thereof, and intaglio micro patterns 122 and 124 or 122a and 124a, so that after pattern transfer is performed in the forming of a duplicated product or an imprinting process, the template can be easily removed without altering the transferred pattern. Also, because a nano and micro patterns may coexist, the technology may be applied to broad-area templates.

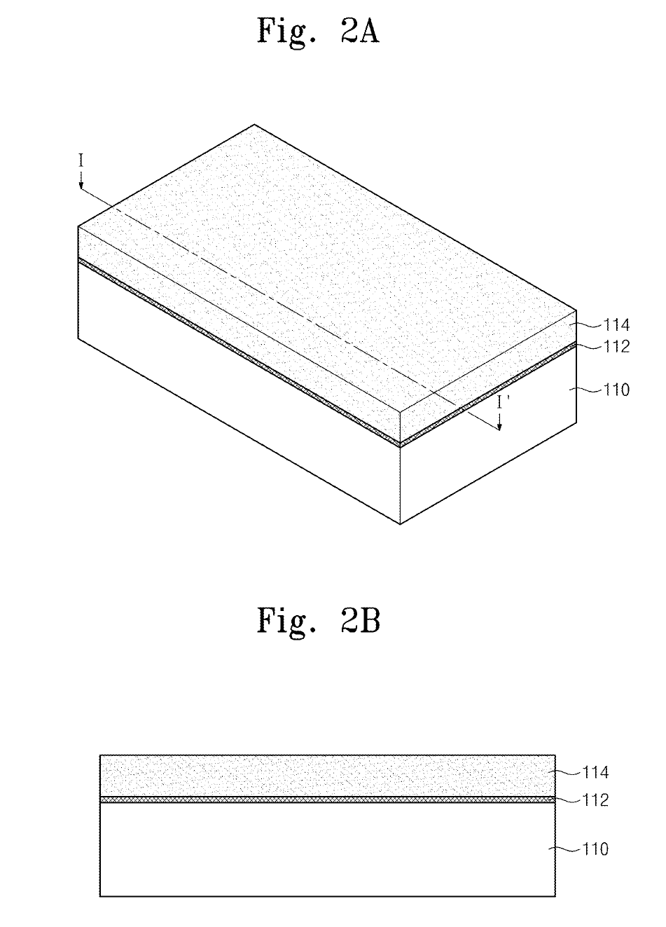

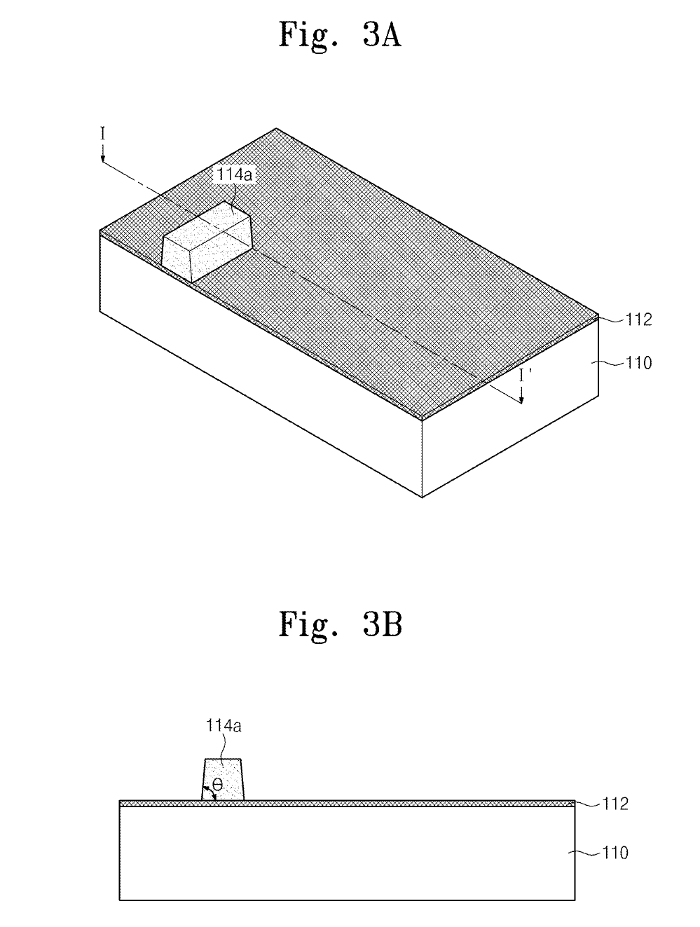

FIGS. 2A to 13A are perspective views illustrating methods for fabricating templates for nanoimprint lithography according to embodiments, and FIGS. 2B to 13B are sectional views of FIGS. 2A to 13A, respectively, taken along lines I-I′.

Referring to FIGS. 2A and 2B, an etch barrier layer 112 is formed on the entire surface of a substrate 110.

The substrate 110 may include glass, quartz, polycarbonate, or silicon. The substrate 110 may also have UV ray transmissivity.

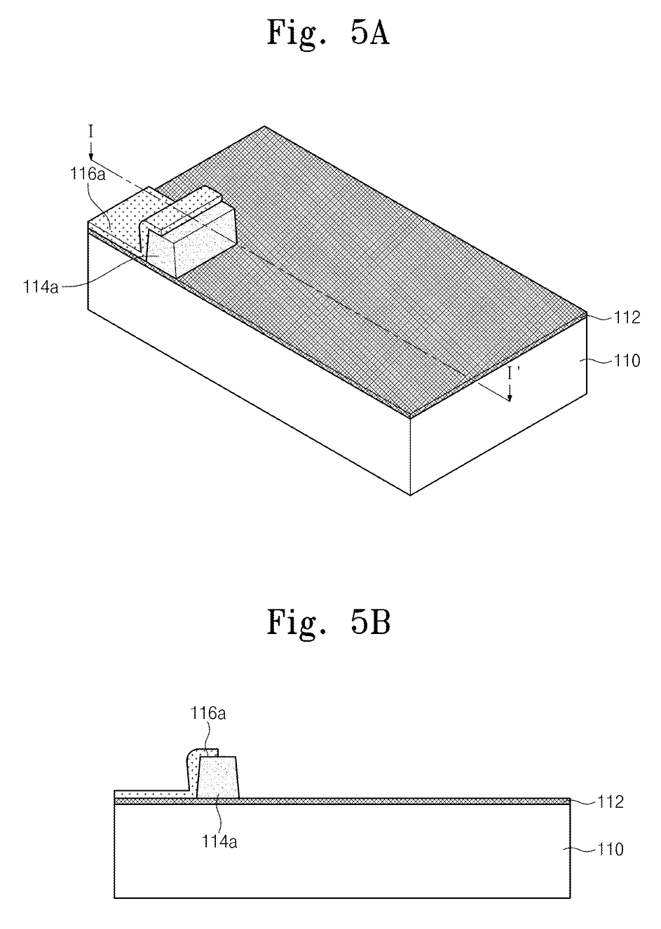

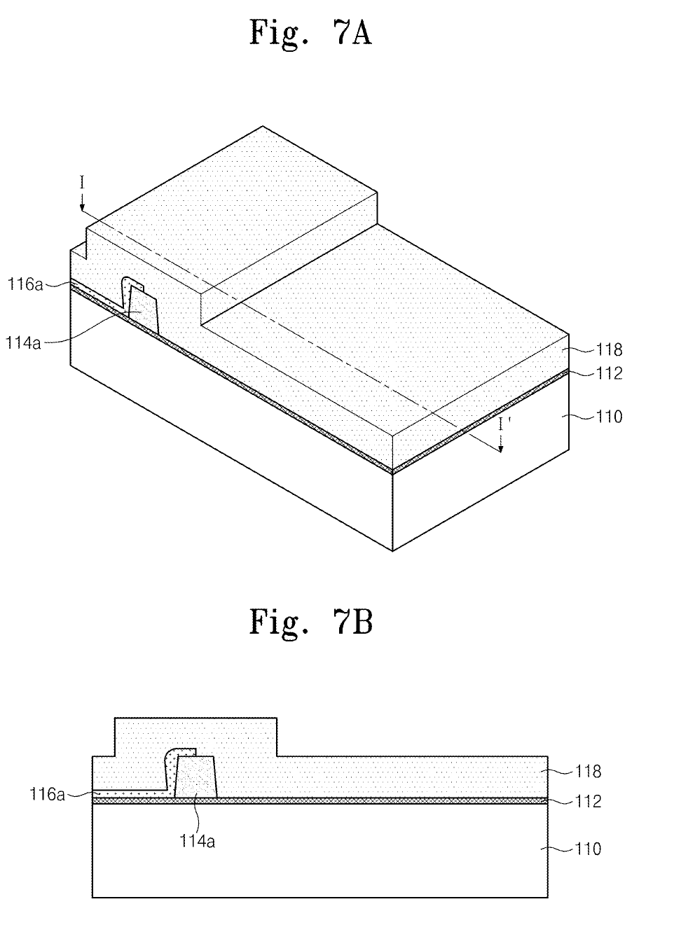

The etch barrier layer 112 may be formed of a material having higher etch selectivity than a first deposition layer 114, a second deposition layer 116 (in FIG. 4A), and a third deposition layer 118 (in FIG. 7A), which are formed later. The etch barrier layer 112 may be used to facilitate patterning of the first deposition layer 114, the second deposition layer, and the third deposition layer.

Here, referring to a material as having higher etch selectivity than another material means that the first material is more difficult to etch than the other material. That is, throughout this specification, when a material is said to be more difficult to etch than another material, the former material is defined as having a high etch selectivity.

Next, the first deposition layer 114 is formed on the etch barrier layer 112.

When the first deposition layer 114, second deposition layer, and third deposition layer have respectively different etch selectivities, the forming of the etch barrier layer 112 may be omitted.

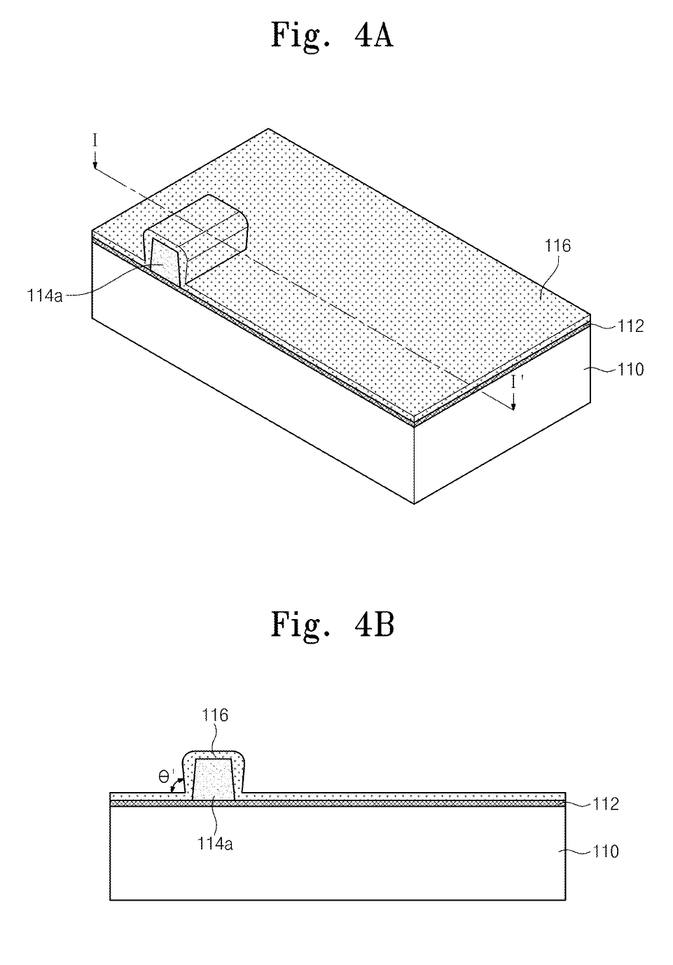

Referring to FIGS. 3A and 3B, the first deposition layer 114 is patterned, and a raised first deposition layer pattern 114a is formed on the substrate 110 to have at least one upward slope (θ) from the surface of the substrate 110.

The first deposition layer 114 may be patterned using typical photolithography and etching processes so that the angle between at least one side surface of the raised first deposition layer pattern 114a and the surface of the substrate 110 ranges from about 80° to about 90°.

Unlike that shown in the illustrations, the raised first deposition layer pattern 114a may be formed in plurality when needed.

Referring to FIGS. 4A and 4B, the second deposition layer 116 is formed on the entire surface of the substrate 110 on which the raised first deposition layer pattern 114a has been formed.

The second deposition layer 116 may be formed with a progressively decreasing width downward from an upper portion of side surfaces of the raised first deposition layer pattern 114a. In order to form the second deposition layer 116 with a progressively decreasing width downward from the upper portion of side surfaces of the raised first deposition layer pattern 114a, the forming of the second deposition layer may use a Plasma Enhanced Chemical Vapor Deposition (PECVD) method or a Low Temperature Low Pressure Chemical Vapor Deposition (LPCVD) method, which have unfavorable step coverage characteristics. Therefore, the second deposition layer 116 may be formed so that an angle (θ′) between an exposed outer wall of the second deposition layer 116 covering the side surfaces of the raised first deposition layer pattern 114a, and the surface of the substrate 110 ranges from about 80° to about 90°.

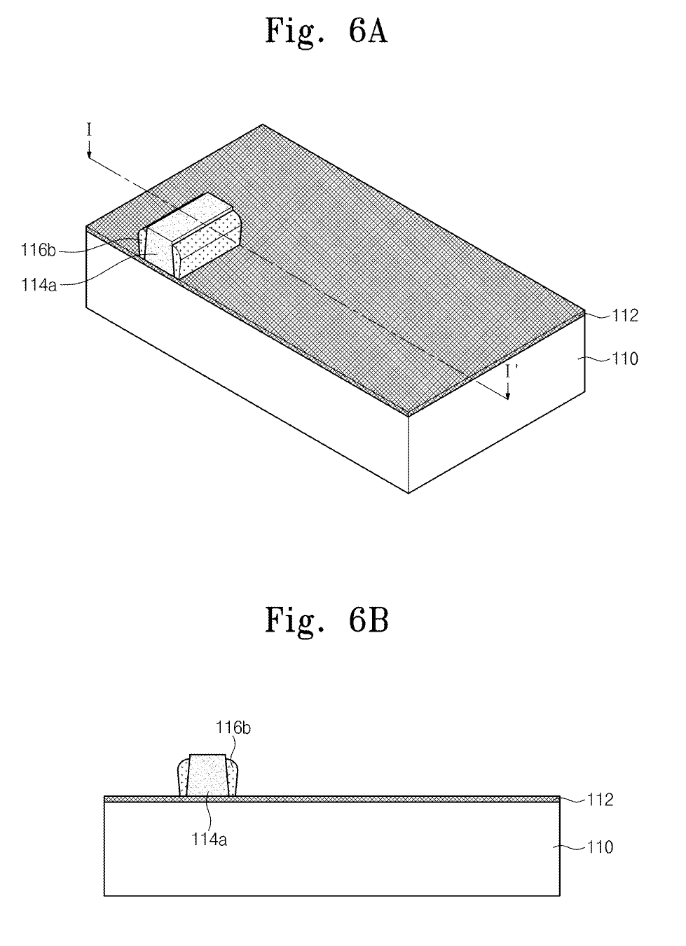

Referring to FIGS. 5A to 6B, the second deposition layer 116 is patterned, and a second deposition layer pattern 116a is formed to cover at least one upwardly sloped side surface of the raised first deposition layer pattern 114a.

FIGS. 5A and 5B illustrate the forming of the second deposition layer pattern 116a that covers at least one side surface of the raised first deposition layer pattern 114a, and the second deposition layer 116 may be patterned using a typical photolithography process and etching process. Conversely, FIGS. 6A and 6B illustrate the forming of a second deposition layer spacer pattern 116b that covers both side surfaces of the raised first deposition layer pattern 114a, and the second deposition layer 116 may be patterned using an etch-back process.

While FIGS. 7A to 13B describe a second deposition layer pattern 116a formed to cover only one side surface of the raised first deposition layer pattern 114a, embodiments may include cases in which the second deposition layer spacer pattern 116b is formed to cover both side surfaces of the raised first deposition layer pattern 114a.

Referring to FIGS. 5A and 5B, the second deposition layer pattern 116a may further cover a portion of the surface of the substrate 110 or/and the upper portion of the raised first deposition layer pattern 114a.

As described above, because the second deposition layer 116 is formed with a progressively decreasing width downward from the upper portion of the side surfaces of the raised first deposition layer pattern 114a, the angles the outer walls facing the side surfaces of the raised first deposition layer pattern 114a of the second deposition layer pattern 116a and the second deposition layer spacer pattern 116b may be in a range from about 80° to about 90°.

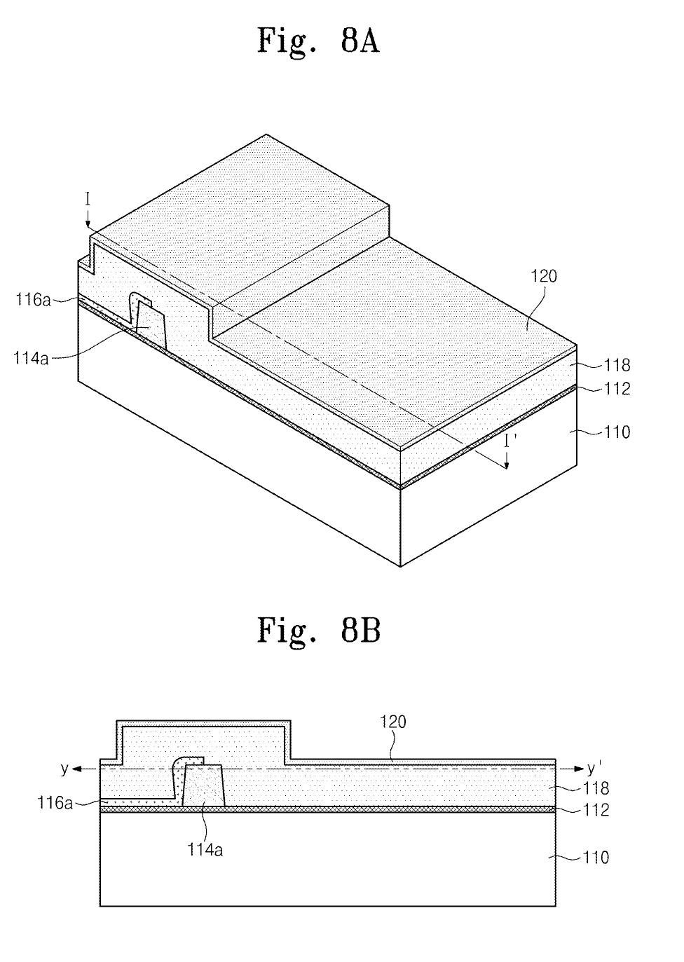

Referring to FIGS. 7A to 8B, a third deposition layer 118 is formed on the entire surface of the structure with the second deposition layer pattern 116a formed.

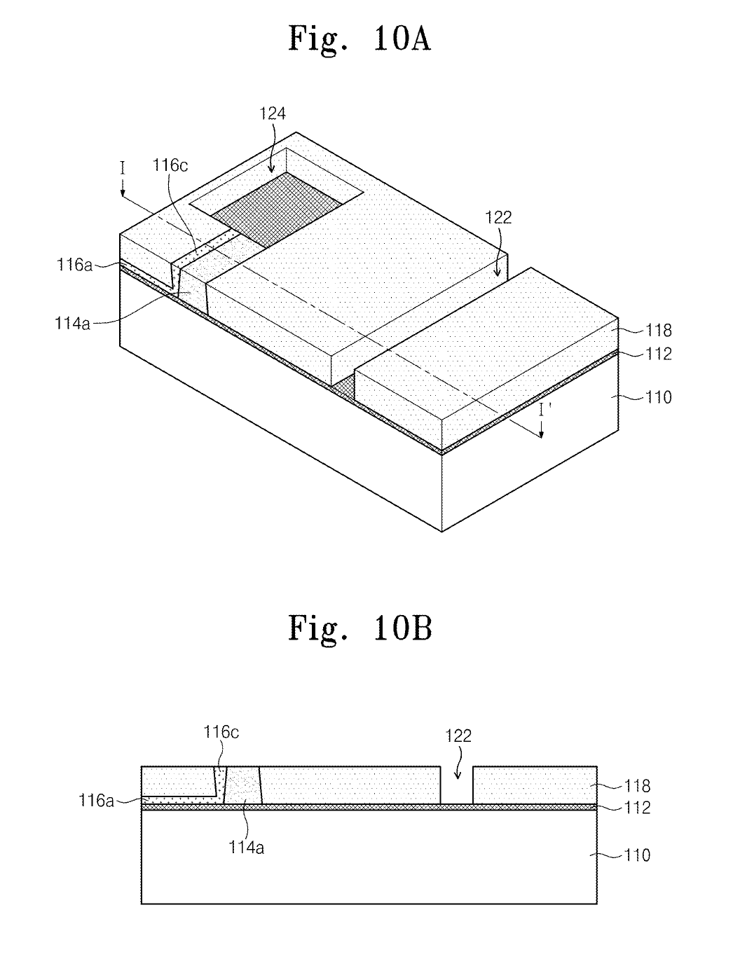

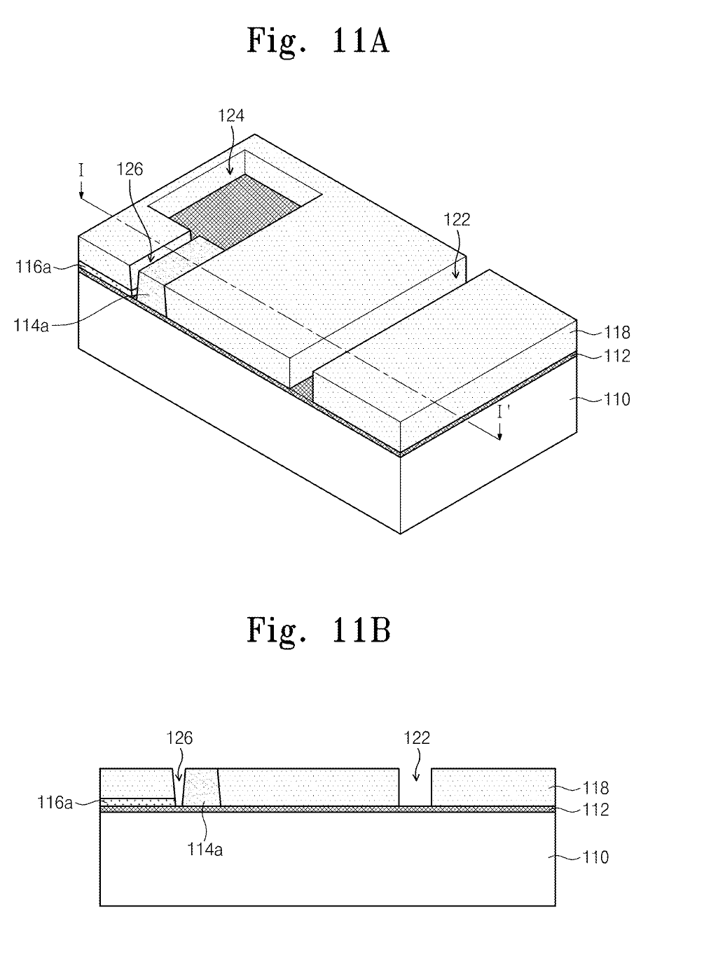

The third deposition layer 118 may be formed of the same material as the first deposition layer 114. This is in consideration of the etch rate and etch selectivity needed later to facilitate forming intaglio micro patterns 122 and 124 (in FIG. 10A) and an intaglio nano pattern 126 (in FIG. 11A). However, the third deposition layer 118 and the first deposition layer 114 need not be formed of the same material.

Referring to FIGS. 8A and 8B, an etch stop layer 120 is further formed on the third deposition layer 118.

The etch stop layer 120 may be formed of a material with higher etch selectivity than the third deposition layer 118. Also, the etch stop layer 120 may be formed of a material with higher etch selectivity than the first deposition layer 114 and the second deposition layer 116. To simultaneously expose the upper surfaces of the raised first deposition layer pattern 114a and the second deposition layer pattern 116a, the etch stop layer 120 may be used to prevent the occurrence of dishing during a planarization process of the third deposition layer 118 to line y-y′. When the third deposition layer 118 is planarized without the etch stop layer 120, the raised first deposition layer pattern 114a and the second deposition layer pattern 116a are formed, and regions of comparatively higher densities in the pattern may be etched more slowly than other regions, so that dishing may occur at the third deposition layer 118. In order to minimize dishing occurrence at the third deposition layer 118, the etch stop layer 120 may be further formed.

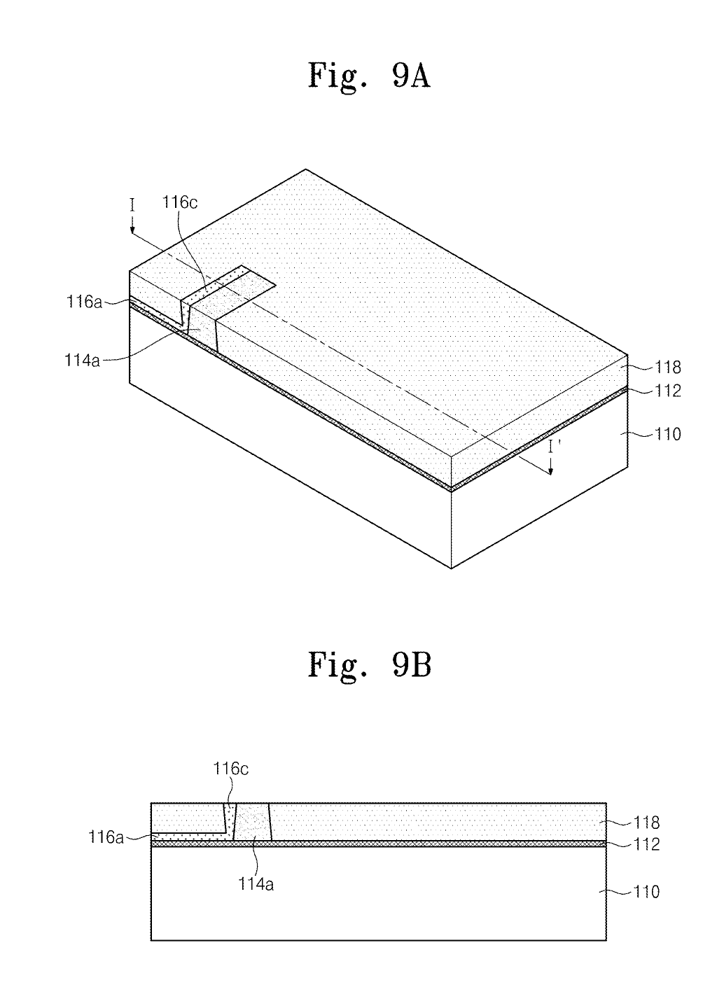

Referring to FIGS. 9A and 9B, the third deposition layer 118 is planarized to simultaneously expose the upper surfaces of the raised first deposition layer pattern 114a and the second deposition layer pattern 116a.

Planarization of the third deposition layer 118 may use a Chemical Mechanical Polishing (CMP) process.

Thus, a second deposition layer nano pattern 116c covering at least one upwardly sloped side surface of the raised first deposition layer pattern 114a may be interposed between the raised first deposition layer pattern 114a and the planarized third deposition layer 118.

Referring to FIGS. 10A and 10B, the planarized third deposition layer 118 is selectively etched to form intaglio micro patterns 122 and 124.

The forming of the intaglio micro patterns 122 and 124 may use a typical photolithography process and etching process. The intaglio micro patterns 122 and 124 may include a groove line-type intaglio micro pattern 122 or/and a hole-type intaglio micro pattern 124. The groove line-type intaglio micro pattern 122 may be for forming metal lines, etc. of a device, and the hole-type intaglio micro pattern 124 may be for forming a contact pad, etc. of a device.

While not shown, the intaglio micro patterns 122 and 124 may be formed in plurality as needed.

Referring to FIGS. 11A and 11B, the second deposition layer nano pattern 116c interposed between the raised first deposition layer pattern 114a and the planarized third deposition layer 118 is removed to form the intaglio nano pattern 126.

The intaglio nano pattern 126 may be configured by means of the respective side surfaces of the raised first deposition layer pattern 114a upwardly sloped from the surface of the substrate 110, and the planarized third deposition layer 118. The intaglio nano pattern 126 may be in the form of a groove line-type pattern. The groove line-type intaglio nano pattern 126 may be for forming a gate line, etc. of a device. Such a groove line-type intaglio nano pattern 126 may be connected to the hole-type intaglio micro pattern 124.

The raised first deposition layer pattern 114a described above may be formed in plurality when needed, and the intaglio nano pattern 126 may also be formed in plurality.

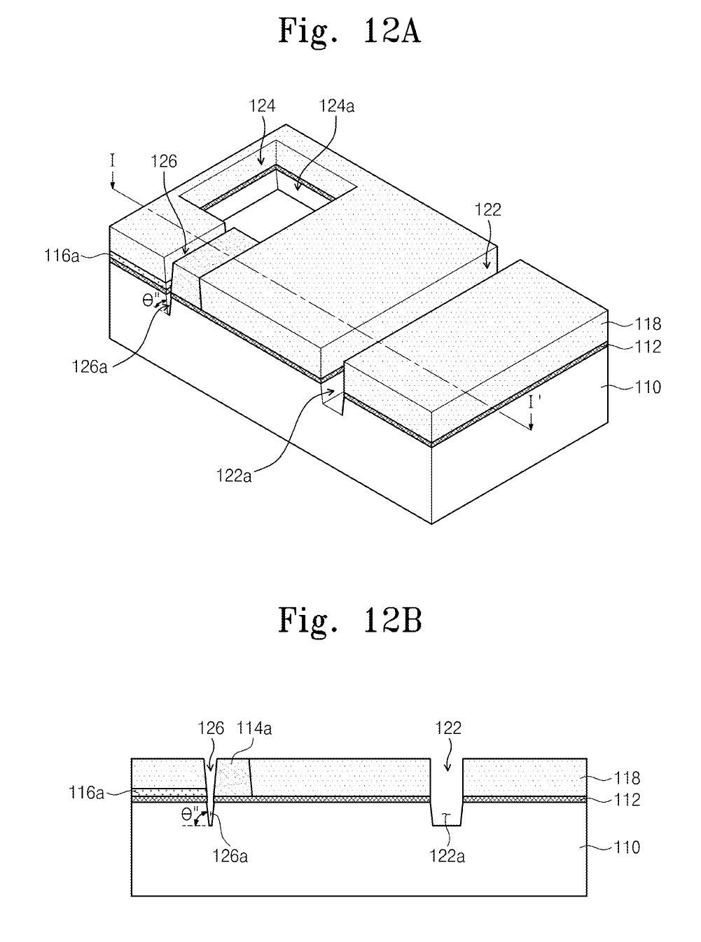

Referring to FIGS. 12A and 12B, the etch barrier layer 112 exposed by the intaglio nano pattern 126 and the intaglio micro patterns 122 and 124 is removed.

The removal of the exposed etch barrier layer 112 may be etching the exposed etch barrier layer 112 through an etching process using the raised first deposition layer pattern 114a and the planarized third deposition layer 118 as a mask.

Then, the intaglio nano pattern 126 and the intaglio micro patterns 122 and 124 are transferred into the substrate 110.

The transferring of the intaglio nano pattern 126 and the intaglio micro patterns 122 and 124 into the substrate 110 may be etching the exposed substrate 110 with an etching process using the raised first deposition layer pattern 114a and the planarized third deposition layer 118 as a mask.

Accordingly, an transferred intaglio nano pattern 126a and transferred intaglio micro patterns 122a and 124a transferred from the surface of the substrate 110 inward may be formed. The transferred intaglio nano pattern 126a may be defined by side surfaces of the substrate 110 having downward slopes from the surface of the substrate 110. The angle of the downwardly sloped side surfaces of the substrate 110 defining the transferred intaglio nano pattern 126a may range from about 80° to about 85°. Further, the transferred intaglio micro patterns 122a and 124a may also be defined by side surfaces of the substrate 110 that slope downwardly from an upper surface of the substrate 110. The downward slopes of the side surfaces of the substrate 110 defining the transferred intaglio micro patterns 122a and 124a may be equal to the downward slopes of the side surfaces of the substrate 110 defining the transferred intaglio nano pattern 126a, or may be greater ranging from about 80° to about 90°.

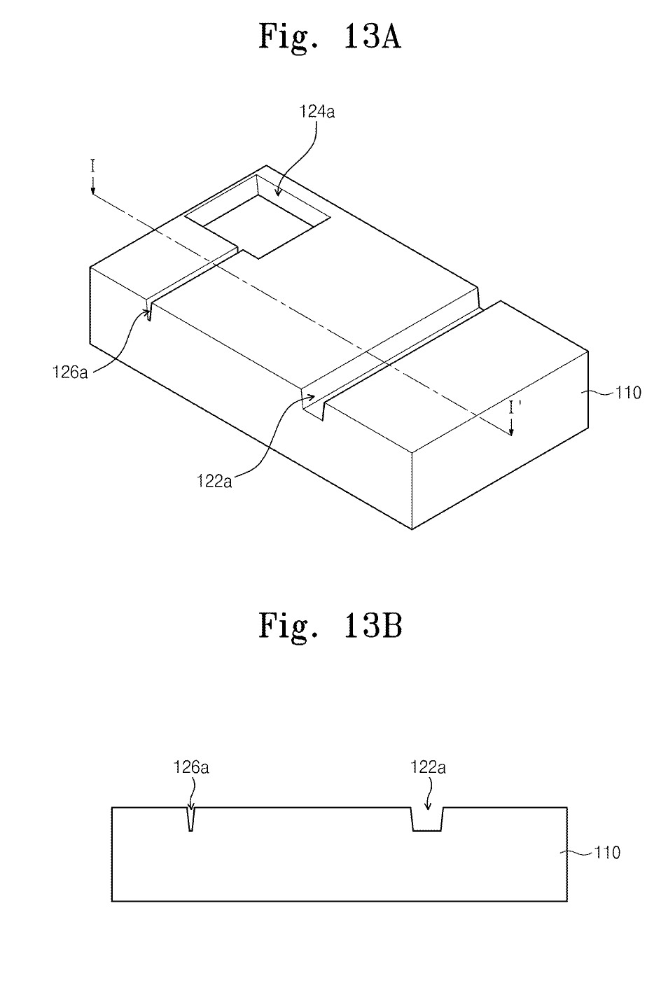

Referring to FIGS. 13A and 13B, after the intaglio nano pattern 126 and the intaglio micro patterns 122 and 124 are transferred into the substrate 110, the planarized third deposition layer 118, the second deposition layer pattern 116a, the raised first deposition layer pattern 114a, and the etch stop layer 112 are removed.

Therefore, the substrate 110 itself may be a template used for nanoimprint lithography, including the transferred intaglio nano pattern 126a and the transferred intaglio micro patterns 122a and 124a.

Because the substrate 110 is etched and transferred by means of an etching process using the raised first deposition layer pattern 114a and the planarized third deposition layer 118 defining the intaglio nano pattern 126 as a mask, smaller dimensions than the transferred intaglio nano pattern 126a may be realized. That is, templates used for nanoimprint lithography may be provided that are capable of forming nano structures of smaller dimensions.

A template used for nanoimprint lithography that is manufactured according to embodiments has intaglio nano patterns 126 or 126a that have downward slopes from an upper surface, and intaglio micro patterns 122 and 124, or 122a and 124a, so that after a pattern is transferred in a duplicate forming process or nanoimprinting process, the template may easily be removed without altering the transferred pattern. Also, because a nano pattern and micro pattern coexist, the technology may be applied to broad-area templates.

Furthermore, because intaglio nano patterns 126 or 126a and intaglio micro patterns 122 and 124, or 122a and 124a for a template used in nanoimprint lithography may be easily adjusted in size, nano patterns and micro patterns of desired shapes may be fabricated. Therefore, templates used for nanoimprint lithography, in which nano and micro patterns coexist, may be provided.

Because sizes of intaglio nano patterns and intaglio micro patterns of a template used for nanoimprint lithography are easily adjusted, nano patterns and micro patterns of wanted shapes may be fabricated. Accordingly, templates used for nanoimprint lithography, in which nano and micro patterns may coexist, may be provided.

Also, because a template used for nanoimprint lithography has intaglio nano patterns and intaglio micro patterns having downward slopes from an upper surface, patterns in replica forming or imprinting processes may be accurately transferred. Therefore, templates used for nanoimprint lithography having improved resolution may be provided as alternatives to limited typical nanoimprint lithography processes using templates that function as a 1X ratio mask. In addition, because nano and micro patterns may coexist, technology may be applied to broad-area templates. Therefore, templates used for nanoimprint lithography that may be applied to mass-production of devices with broad areas may be provided.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, the present invention shall not be restricted or limited by the foregoing detailed description.

What is claimed is:

1. A template used for nanoimprint lithography, comprising:
a substrate; and
layer patterns defining an intaglio nano pattern and a micro pattern on the substrate,
wherein the layer patterns defining the intaglio nano pattern include side surfaces with a downward slope from upper surfaces thereof.

2. The template of claim 1, wherein the layer patterns defining the intaglio micro pattern include side surfaces with a downward slope from upper surfaces thereof.

3. The template of claim 1, further comprising an etch barrier layer interposed between the substrate and the layer patterns.

4. A template used for nanoimprint lithography, comprising a substrate with an intaglio nano pattern and an intaglio micro pattern formed inward from a surface of the substrate,
wherein the substrate defining the intaglio nano pattern includes side surfaces with a downward slope from the surface of the substrate.

5. The template of claim 4, wherein the substrate defining the intaglio micro pattern includes side surfaces with a downward slope from the surface of the substrate.

6. A method for fabricating a template used for nanoimprint lithography, the method comprising:
forming a raised first deposition layer pattern on a substrate, the raised first deposition layer pattern including at least one side surface sloped downward from an upper surface thereof to a surface of the substrate;
forming a second deposition layer pattern to cover the at least one downwardly sloped side surface of the raised first deposition layer pattern, the second deposition layer pattern having a progressively decreasing width downward from an upper portion to a lower portion of the side surface of the raised first deposition layer pattern;
forming a third deposition layer on an entire surface of a structure on which the second deposition layer pattern is formed;
forming a second deposition layer nano pattern by planarizing the third deposition layer to simultaneously expose upper surfaces of the raised first deposition layer pattern and the second deposition layer pattern, the second deposition layer nano pattern between the raised first deposition layer pattern and the planarized third deposition layer; and
forming an intaglio nano pattern by removing the second deposition layer nano pattern from between the raised first deposition layer pattern and the planarized third deposition layer, the intaglio nano pattern defined by side surfaces sloped downward from upper surfaces of the raised first deposition layer pattern and the planarized third deposition layer to the surface of the substrate.

7. The method of claim 6, further comprising forming an intaglio micro pattern through selectively etching the planarized third deposition layer.

8. The method of claim 6, wherein the forming the raised first deposition layer pattern comprises:
depositing a first deposition layer on the substrate; and
patterning the first deposition layer to have at least one side surface downwardly sloped from the upper surface of the first deposition layer to the surface of the substrate.

9. The method of claim 8, wherein the at least one downwardly sloped side surface forms an angle with the surface of the substrate of between about 80° to about 90°.

10. The method of claim 6, further comprising, prior to the forming the raised first deposition layer pattern, forming an etch barrier layer on an entire surface of the substrate.

11. The method of claim 10, wherein the etch barrier layer is formed of a material with higher etch selectivity than the raised first deposition layer pattern, the second deposition layer pattern, and the third deposition layer.

12. The method of claim 10, further comprising, following the forming the intaglio nano pattern, removing the etch barrier layer exposed by the intaglio nano pattern through an etching process using the raised first deposition layer pattern and the planarized third deposition layer as a mask.

13. The method of claim 6, wherein the forming the second deposition layer pattern comprises:
depositing a second deposition layer on an entire surface of a structure on which the raised first deposition layer pattern is formed, the second deposition layer being progressively reduced in width from the upper portion to the lower portion of the side surface of the raised first deposition layer pattern; and
patterning the second deposition layer to cover the at least one downwardly sloped side surface of the raised first deposition layer pattern.

14. The method of claim 13, wherein the depositing the second deposition layer uses a Plasma Enhanced Chemical Vapor Deposition (PECVD) method or a low temperature Low Pressure Chemical Vapor Deposition (LPCVD) method.

15. The method of claim 13, wherein the second deposition layer pattern is formed as a spacer for covering the side surfaces of the raised first deposition layer pattern.

16. The method of claim 6, wherein the planarizing the third deposition layer uses a Chemical Mechanical Polishing (CMP) method.

17. The method of claim 6, further comprising, prior to the planarizing the third deposition layer, forming an etch stop layer on the third deposition layer.

18. The method of claim 17, wherein the etch stop layer is formed of a material with higher etch selectivity than the third deposition layer.

19. The method of claim 6, further comprising transferring the intaglio nano pattern into the substrate through an etching process using the raised first deposition layer pattern and the planarized third deposition layer as a mask, to provide the substrate with side surfaces sloping downward from the surface thereof.

20. The method of claim 19, further comprising, following the transferring the intaglio nano pattern into the substrate, removing the planarized third deposition layer, the second deposition layer pattern, and the raised first deposition layer pattern.
